(19) United States
(12) Patent Application Publication
(10) Pub. No.: US 2023/0247466 A1
(43) Pub. Date: Aug. 3, 2023

(54) NODE, USER EQUIPMENT AND METHODS THEREOF IN COMMUNICATION SYSTEM

(71) Applicant: Samsung Electronics Co., Ltd., Gyeonggi-do (KR)

(72) Inventors: Lisi LI, Beijing (CN); Lixiang Xu, Beijing (CN); Hong Wang, Beijing (CN)

(21) Appl. No.: 18/103,029

(22) Filed: Jan. 30, 2023

(30) Foreign Application Priority Data
Jan. 29, 2022 (CN) 202210112959.9
Feb. 9, 2022 (CN) 202210122592.9

(51) Int. Cl. H04W 24/10; H04W 24/08

(52) U.S. Cl. CPC H04W 24/10; H04W 24/08

(57) ABSTRACT

The present application discloses a node, a UE and methods thereof. A method performed by a third node in a communication system includes receiving information about a first measurement from a first node; and in response, sending configuration information of the first measurement to the first node; or sending a first measurement report received from a UE to a fourth node.

### CROSS-REFERENCE TO RELATED APPLICATION(S)

This application is based on and claims priority under 35 U.S.C. § 119 to Chinese Patent Application Nos. 202210112959.9 and 202210122592.9, which were filed in the China National Intellectual Property Administration on Jan. 29, 2022, and Feb. 9, 2022, respectively, the entire disclosure of each of which is incorporated herein by reference in their entirety.

### BACKGROUND

### 1. Field

This application generally relates to the field of communications.

### 2. Description of Related Art

In order to meet the increasing demand for wireless data communication services since the deployment of 4^{th} generation (4G) communication systems, efforts have been made to develop improved 5^{th} generation (5G) or pre-5G communication systems. 5G or pre-5G communication systems may also be referred to as “beyond 4G networks” or “post-long term evolution (LTE) systems”.

Wireless communication is one of the most successful innovations in modern history. Recently, the number of subscribers to wireless communication services has exceeded 5 billion and continues to grow rapidly. Further, the demand for wireless data services is growing rapidly due to the increasing popularity of smartphones and other mobile data devices (e.g., tablets, notebook computers, netbooks, e-book readers, machine-type devices, etc.) among consumers and businesses. In order to meet the rapid growth of mobile data services and support new applications and deployments, it is critical to improve efficiency and coverage of wireless interfaces.

### SUMMARY

The present disclosure is designed to address at least the problems and/or disadvantages described above and to provide at least the advantages described below.

According to an aspect of the disclosure, a method performed by a third node in a communication system is provided. The method includes receiving, from a first node, information about a first measurement; and performing at least one of sending configuration information of the first measurement to the first node, or sending, to a fourth node, a first measurement report received from a user equipment (UE).

According to another aspect of the disclosure, a method performed by a first node in a communication system is provided. The method includes sending, to a third node, information about a first measurement; and receiving, from the third node, configuration information of the first measurement.

According to another aspect of the disclosure, a third node is provided for performing communication in a communication system. The third node includes a transceiver; and a processor coupled to the transceiver and configured to perform the above method performed by the first node or the third node.

According to another aspect of the disclosure, a UE is provided, which includes a transceiver; and a processor coupled to the transceiver and configured to receive, from a first node, information about a first measurement, and perform at least one of sending configuration information of the first measurement to the first node, or sending, to a fourth node, a first measurement report received from a user equipment (UE).

### BRIEF DESCRIPTION OF DRAWINGS

The above and other aspects, features, and advantages of certain embodiments of the disclosure will be more apparent from the following detailed description taken in conjunction with the accompanying drawings, in which:

FIG. 1 illustrates system architecture for system architecture evolution (SAE);

FIG. 2 illustrates system architecture according to an embodiment;

FIG. 3 illustrates a process for configuring and reporting quality of experience (QoE) measurement collection (QMC), according to an embodiment;

FIG. 4 is a flowchart illustrating a method for measurement configuration and reporting according to an embodiment;

FIG. 5 is a signal flow diagram of a method for measurement configuration and reporting according to an embodiment;

FIG. 6 is a flowchart illustrating a method for measurement configuration and reporting according to an embodiment;

FIGS. 7A and 7B are signal flow diagrams of a method for measurement configuration and reporting according to an embodiment;

FIGS. 8A and 8B are signal flow diagrams of a method for measurement configuration and reporting according to an embodiment;

FIG. 9 illustrates a node according to an embodiment;

FIG. 10 illustrates a UE according to an embodiment; and

FIG. 11 is a flowchart illustrating a method for measurement configuration and reporting according to an embodiment.

### DETAILED DESCRIPTION

The following description, with reference to the accompanying drawings, is provided to facilitate a comprehensive understanding of various embodiments of the disclosure as defined by the claims and equivalents thereof. This description includes various specific details to facilitate understanding but should be regarded as exemplary only. Accordingly, those of ordinary skill in the art may recognize that various changes and modifications may be made to various embodiments described herein without departing from the scope and spirit of the present disclosure.

In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, those skilled in the art will understand that the following description of various embodiments of the disclosure is provided for illustration purposes only and not for the purposes of limiting the present disclosure as defined by the appended claims and their equivalents.

Herein, singular forms such as “a,” “an,” and “the” include plural referents unless the context clearly dictates otherwise. Thus, for example, reference to “a component surface” includes reference to one or more of such surfaces.

Terms such as “include” or “may include” refer to the existence of a corresponding disclosed function, operation or component which can be used in various embodiments of the present disclosure and does not limit one or more additional functions, operations, or components. Terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

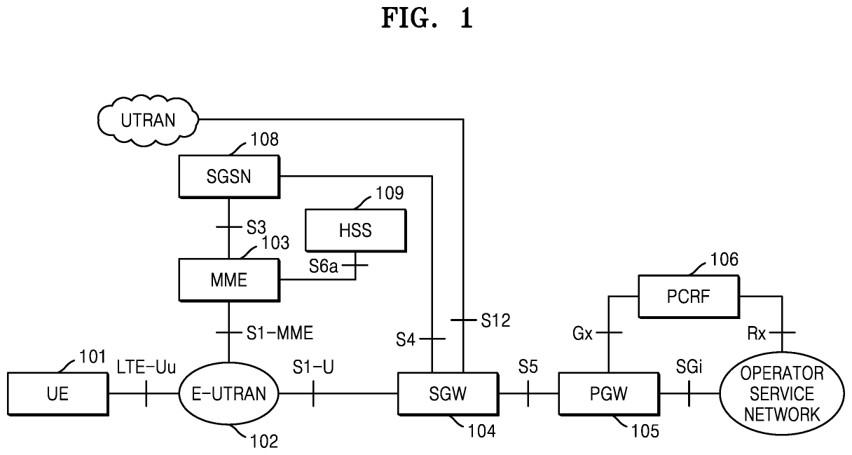

FIGS. 1 to 11 and the various embodiments used to describe the principles of the disclosure herein are for illustration only and should not be construed in any way to limit the scope of the disclosure. Those skilled in the art may understand that the principles of the present disclosure may be implemented in any suitably arranged system or device.

FIG. 1 illustrates system architecture for system architecture evolution (SAE).

Referring to FIG. 1, a UE 101 is a terminal device configured to receive data. An evolved universal terrestrial radio access network (E-UTRAN) 102 is a radio access network (RAN) that includes a macro base station (e.g., an eNodeB/NodeB) that provides the UE with an interface to access a radio network. A mobility management entity (MME) 103 is configured to manage a mobility context, a session context and security information of the UE. A serving gateway (SGW) 104 mainly provides functions of a user plane. The MME 103 and the SGW 104 may be located in a same physical entity.

A packet data network gateway (PGW) 105 is configured to provide functions such as charging and lawful interception, and may also be in a same physical entity as the SGW 104. A policy and charging rules function entity (PCRF) 106 provides a quality of service (QoS) policy and a charging standard. A serving general packet radio service support node (SGSN) 108 is a network node device in a universal mobile telecommunications system (UMTS) that provides routing for data transmission. A home subscriber server (HSS) 109 is a home subsystem of the UE, and is configured to protect user information including a current location of the UE, an address of the serving node, user security information, and a packet data context of the UE, etc.

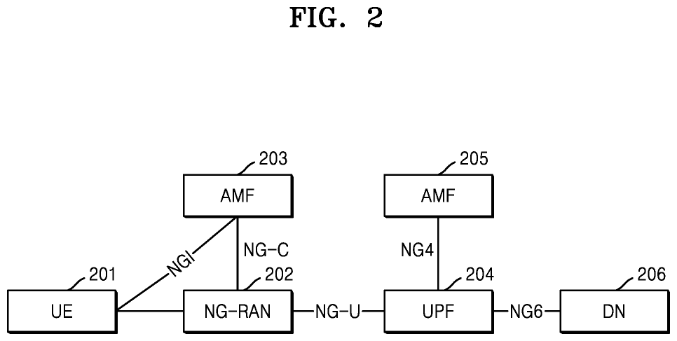

FIG. 2 illustrates system architecture according to an embodiment.

Referring to FIG. 2, a UE 201 is a terminal device configured to receive data. A next generation (NG) RAN (NG-RAN) 202 is a RAN that includes a base station (e.g., a gNB or eNB connected to a 5G core network (5GC), also referred to as an ng-gNB) that provides the UE with an interface to the radio network. An access control and mobility management function (AMF) 203 is configured to manage a mobility context and security information of the UE. A user plane function entity (UPF) 204 provides functions of a user plane. A session management function entity (SMF) 205 is configured for session management. A data network (DN) 206 may include services of carriers, Internet access, third-party services, etc.

With the development needs of wireless technologies, in the 5G architecture, functional modules originally located on a same base station are being separated. Some functional modules are getting closer to users, while others are pooled and virtualized for centralized deployment. In other words, a base station may be divided into different parts, one of which may be a central unit (CU), and the other one of which may be a distributed unit (DU). The DU is often closer to a user, while the CU is often farther away from the antenna, which may support multi-antenna connections and improve network performance. One CU may be connected to multiple DUs, and functions on the CU may be virtualized. The CU and DU are connected through an F1 interface, which is also referred to as a fronthaul (forward backhaul) interface or a fronthaul connection. The functions of radio resource control (RRC) and packet data convergence protocol (PDCP) are implemented on the CU, and radio link control (RLC), media access control (MAC) and physical layer functions are implemented on the DU.

In 3rd generation (3G) and 4G mobile communication systems, the QMCs for streaming media services and multimedia telephony services have been standardized by the 3G partnership project (3GPP). The QMC may collect measurement information of a UE application layer, which may be measurement collection performed in a certain area or for a specific service type of a specific UE. The collected information may be transmitted to a data center (e.g., a measurement collection entity (MCE)) for analysis and/or calculation of key performance indicators (KPIs) to optimize the network and improve user service experiences, and ultimately enhance user loyalty and increase revenue.

In 5G and beyond 5G (B5G) or 6G mobile communication systems, more and more new services need to be supported, e.g., new 5G services such as augmented reality (AR), mixed reality (MR), and cloud games. In addition, the multi-radio access technology dual-connectivity MR-DC is an important commercial deployment scenario of 5G networks. Therefore, it is also an important studying direction to find better ways to collect QoE to optimize the network in MR-DC scenarios.

A measurement configuration and reporting method or device for assisting QoE optimization in accordance with an embodiment of the disclosure may help carriers obtain auxiliary measurement information corresponding to QoE measurements while collecting service QoE. Carriers may use auxiliary measurement results to more rapidly and accurately analyze reasons for deteriorated QoE, in order to optimize the network more accurately, and improve the QoE of service for user, thereby enhancing user loyalty and increasing revenue of carriers.

Herein, a QMC may also be referred to as a QoE measurement, which refers to the QoE measurement configured by the 3GPP network and performed by the UE. Results of these measurements may be reported to a 3GPP network or a server of a carrier.

According to an initiation method, QoE measurements may be divided into management-based QoE measurements and signaling-based QoE measurements. According to an implementation, the QMC may be initiated by a network element management node, and this type of QMC may be referred to as management-based QMC. In a management-based QMC, an access network entity receives a QMC configuration message from a network element management node.

According to another implementation, a QMC may be initiated by a core network entity. This type of QMC may be referred to as signaling-based QMC. In a signaling-based QMC, an access network entity receives a QMC configuration message from a core network entity. For example, the core network entity may be an AMF entity. However, it should be understood that this is only an example. A core network entity, a network element management entity, or another entity (e.g., a base station) may send a QMC configuration message.

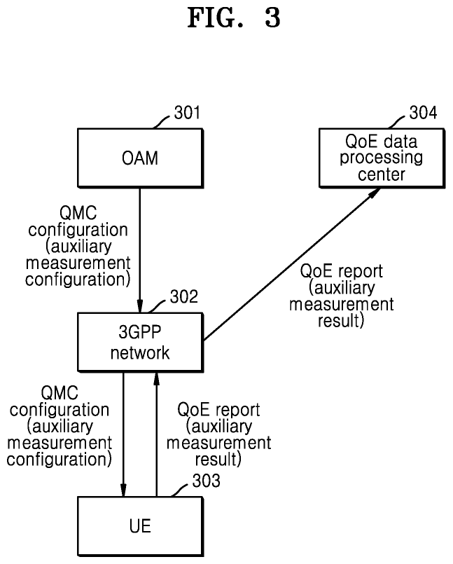

FIG. 3 illustrates a process for configuring and reporting QMC according to an embodiment.

Referring to FIG. 3, an operations, administration and maintenance (OAM) node 301 sends a QMC configuration message to a 3GPP network 302. The 3GPP network 302 may include a core network node or an access network node. The core network node may include various nodes, such as a universal data management (UDM), an AMF, an SMF UPF, etc., and the access network node may be an eNB of a 4G system or a gNB or eNB of a 5G system, or may also be a base station in another system.

The QMC configuration message includes QMC configuration information and/or auxiliary measurement configuration information. The auxiliary measurement configuration information refers to configuration information of an associated auxiliary measurement performed by nodes in a 3GPP network and/or a UE access layer while a UE application layer measures QoE, for optimizing analysis of the QoE problem. The associated auxiliary measurement refers to auxiliary measurements that should be temporally consistent or aligned with application layer measurements.

The 3GPP network 302 may initiate (and/or trigger) a process for activating the QMC. According to different nodes that initiate and/or trigger the process for activating the QMC, the process may be divided into a management-based QMC process and a signaling-based QMC process. If the process for activating the QMC is directly triggered by the OAM through the base station, this process belongs to a management-based QMC process. If the process for activating the QMC is triggered by a core network node, this process belongs to a signaling-based QMC process.

Regardless of the triggering method, the 3GPP network 302 may send the QMC configuration to the UE that meets the conditions. If the QMC configuration includes an auxiliary measurement configuration, and the auxiliary measurement configuration may be for the network node or for the UE. The network node configured with the auxiliary measurement also saves information of the auxiliary measurement configuration, and activate measurement at an appropriate time.

At the beginning of each service session, a UE 303 determines whether to enable QoE measurement according to the conditions in the configuration, while the network node configured with the auxiliary measurement also performs an associated auxiliary measurement. The UE 303 transfers a measurement result (including a QoE report and/or an auxiliary measurement result) to a configured QoE data processing center 304 through the access network node in the 3GPP network 302. The QoE data processing center 304 may be a tracking collection entity (TCE)/MCE. The network nodes configured with auxiliary measurement in the 3GPP network 302 should also send the measurement results to the QoE data processing center 304, so that the carrier performs further QoE problem analysis and network optimization.

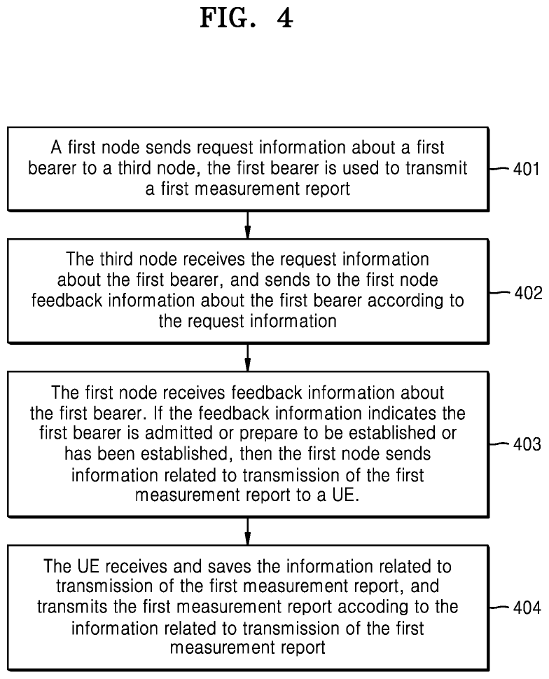

FIG. 4 is a flowchart illustrating a method for measurement configuration and reporting according to an embodiment.

Referring to FIG. 4, in step 401, a first node sends request information about a first bearer to a third node. The first bearer is a bearer configured to transmit a first measurement report. The first node and the third node may be base stations (e.g., gNBs or eNBs). The first node may be a master node (MN) serving the UE in a multi-connectivity (e.g., MR-DC), and the third node may be a secondary node (SN) serving the UE.

The first measurement corresponding to the first measurement report may be a measurement performed by the UE application layer, such as QoE measurement, but is not limited thereto. The first bearer has at least an RLC bearer between the UE and the third node. For example, the first bearer may be a signaling radio bearer (SRB) SRB3, a split SRB (e.g., a split SRB4) or a new SRB.

According to an embodiment, the first bearer is an SRB3 initiated and established by the third node, and the SRB3 may be configured to transmit other signaling messages (e.g., a measurement report for mobility management) in addition to transmitting the first measurement report. By selecting SRB3 as the first bearer to transmit the first measurement report, the SN may directly receive an RRC message including the first measurement report, and forward the first measurement report to a fourth node in time.

According to another embodiment, the first bearer is initiated and established by the first node. For example, the first bearer may include a bearer (e.g., an RLC bearer) between the UE and the SN in a split SRB (i.e., it may be split SRB1, a split SRB2, a split SRB4, etc.), or a new bearer. The split SRB refers to an SRB having an RLC bearer between the MN and the UE and on both a master cell group (MCG) and a secondary cell group (SCG). The new bearer is configured to transmit the first measurement report.

If the split SRB is selected as the first bearer to transmit the first measurement report, the UE may more flexibly select a transmission path, improving utilization rate of network resources. If the new bearer is selected as the first bearer to transmit the first measurement report, the first measurement report may be independently scheduled without affecting reception of other measurement reports.

It should be understood that the above is only an example, as long as the first bearer may transmit the first measurement report via the MN and/or SN, and the type of the first bearer is not limited thereto.

In step 402, the third node receives the request information about the first bearer, and sends to the first node feedback information about the first bearer according to the information. The request information about the first bearer may include information for requesting information about the first bearer or information for requesting establishment of the first bearer.

According to an embodiment, if the first bearer is initiated and established by the third node, the sending, by the first node, request information about the first bearer to the third node may include sending, by the first node to the third node, information for requesting information about the first bearer. In this embodiment, the information about the first bearer may include information about whether the first bearer has been established by the third node or is information about whether the first bearer is prepared to be established by the third node. The third node receives the information, and sends to the first node feedback information about the first bearer according to the situation for feeding back the information about the first bearer.

According to another embodiment, if the first bearer is initiated and established by the first node, the sending, by the first node to the third node, the request information about the first bearer may include sending, by the first node to the third node, information for requesting establishment of the first bearer. The third node establishes the first bearer according to the information, and sends to the first node feedback information about the first bearer for feeding back the information about the establishment of the first bearer.

It should be understood that the above is only an example, and the request information about the first bearer, the feedback information about the first bearer, and related processes are not limited thereto.

In step 403, the first node receives feedback information about the first bearer from the third node.

If the feedback information about the first bearer indicates that the first bearer is successfully established or is prepared to be established or is permitted to be established, the first node, sends to the UE, information related to transmission of the first measurement report. The information related to transmission of the first measurement report is used to instruct the UE how to transmit the first measurement report (e.g., transmit the first measurement report over the first bearer or not over the first bearer, or transmit the first measurement report over the third node or not over the third node), and the information related to transmission of the first measurement report may be configured to the UE in advance, or may be dynamically indicated to the UE by the first node according to a situation (e.g., base station load).

In step 404, the UE receives the information related to transmission of the first measurement report, and when the UE needs to transmit the first measurement report, the UE selects to transmit the first measurement report through the MN and/or SN according to the information related to transmission of the first measurement report (i.e., select whether to use the first bearer to transmit the first measurement report).

If the UE selects the SN (or the SCG or the first bearer) to transmit the first measurement report, the third node serving as the SN receives the first measurement report, and forwards the first measurement report to the first node or fourth node. The fourth node may be an MCE or a base station, and the fourth node may be the same as or different from the first node. When the fourth node is different from the first node, after receiving the first measurement report, the first node should continue to forward the first measurement report to the fourth node. The fourth node may perform problem analysis according to the collected first measurement report, so as to optimize and adjust the network, thereby improving user experience.

Through the above wireless communication method, when a master base station (or MN) has a high load, the UE may also transmit the measurement report of the UE (such as an application layer measurement report) through a secondary base station (or SN). This may ensure integrity and timeliness of transmission of the measurement report of the UE in the case the master base station has a high load, so that the carrier may obtain a complete measurement report and optimize and adjust the network, improving user experience. The above-described method allows the master base station to dynamically adjust a transmission path of the measurement report according to the load situation to achieve effect of load balancing, and allows the UE to be configured with a transmission method in advance, so that the UE may determine how to transmit the measurement report according to the actual situation, without the need for frequently instructing, by the master base station, the UE how to report the measurement result through signaling, thereby saving a lot of signaling overhead of the radio interface.

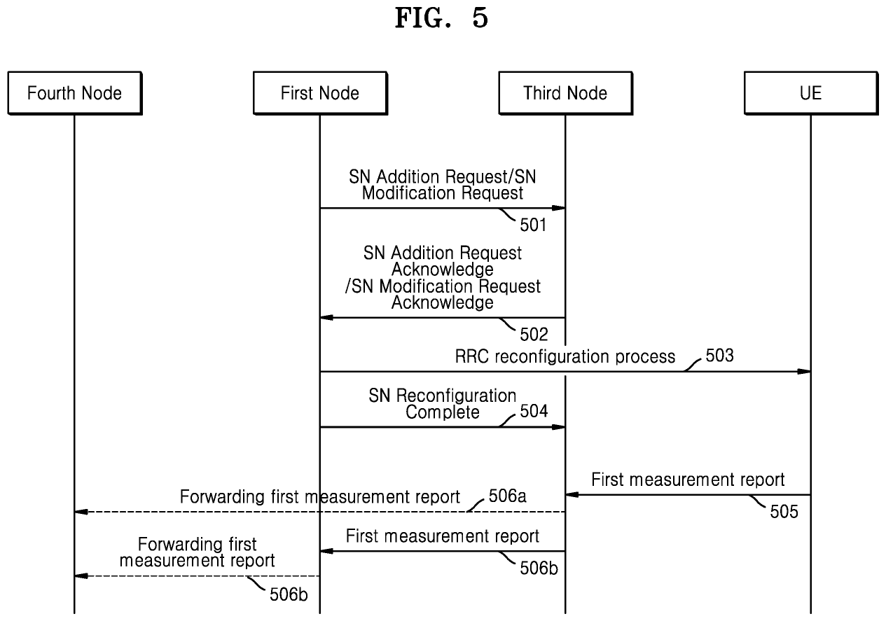

FIG. 5 is a signal flow diagram of a method for measurement configuration and reporting according to an embodiment.

Referring to FIG. 5, in step 501, a first node sends an SN addition request message or an SN modification request message to a third node. The first node may be an MN serving a UE in a multi-connectivity (e.g., MR-DC), and the third node may be an SN serving the UE. The message includes request information about the first bearer. The first bearer may be, but is not limited to an SRB3, and a split SRB4 or a new bearer. The request information about the first bearer may include at least one of:

1) information indicating the presence of a first measurement, e.g., information used to indicate that the first measurement has been configured to the UE, or the first measurement is in progress, etc., wherein the third node may consider the information for indicating presence of the first measurement to determine whether to establish a first bearer for transmitting the first measurement report and/or to determine whether to feed back information about the first bearer to the first node;

2) information requesting information about the first bearer, e.g., information used to request information about an SRB3, to acquire whether the third node has established the SRB3; and/or

3) information requesting establishment of the first bearer, such as information requesting establishment of a split SRB4 or a new SRB (e.g., an SRB5), wherein the new SRB may be a bearer used for transmitting the first measurement report between the UE and the SN.

In step 502, after receiving the message and the information, the third node sends, to the first node, a message including feedback information about the first bearer. If the SN addition request message or the SN modification request message includes information for indicating that there is the first measurement, the third node may consider the information to determine whether to permit establishment of the first bearer. If the establishment of the first bearer is permitted, the information for indicating permission to establish the first bearer may be included in an SN addition request acknowledge message or an SN modification request acknowledge message as feedback information about the first bearer.

Alternatively, if the SN addition request message or the SN modification request message includes information for indicating presence of the first measurement, the third node may consider the information to determine whether to feed back the information about the first bearer to the first node. If the third node prepares to establish and/or establishes the first bearer, the information for indicating prepare to establish and/or the establishment of the first bearer may be included in the SN addition request acknowledge message or the SN modification request acknowledge message as feedback information about the first bearer.

According to another embodiment, if the SN addition request message or the SN modification request message includes information for requesting information about the first bearer, the third node determines whether to feed back information about the first bearer to the first node according to its own situation. If the third node prepares to establish and/or establishes the first bearer, the information for indicating prepare to establish and/or establishment of the first bearer may be included in the SN addition request acknowledge message or the SN modification request acknowledge message as feedback information about the first bearer.

According to yet another embodiment, if the SN addition request message or the SN modification request message includes information for requesting the establishment of the first bearer, the third node determines whether to permit establishment of the first bearer according to its own situation. If the third node permits the establishment of the first bearer, the third node includes the information for indicating permission to establish the first bearer in the SN addition request acknowledge message or the SN modification request acknowledge message.

It should be understood that the above are only examples, and the operations performed by the third node according to the request information about the first bearer is not limited thereto.

Sending, by the third node, the message including the feedback information about the first bearer to the first node may include sending, by the third node, an SN addition request acknowledge message or an SN modification request acknowledge message to the first node. If the establishment of the first bearer is permitted, the message includes information for indicating permission to establish of the first bearer. If the establishment of the first bearer is not permitted, the message includes information for indicating no permission to establish the first bearer, or the message does not include information for indicating permission to establish the first bearer. In the case that the third node permits the establishment of the first bearer, the first node will establish the corresponding bearer through an appropriate procedure.

In step 503, after the first node receives the SN addition request acknowledge message or the SN modification request acknowledge message, if the message includes information for indicating permission to establish the first bearer, the first node sends, to the UE, the information related to transmission of the first measurement report. The information related to transmission of the first measurement report may be RRC layer information, or may be a MAC control element (CE) of the MAC layer. If the information related to transmission of the first measurement report is a MAC CE of the MAC layer, the MAC CE is used to indicate the path (or paths) through which the UE transmits the first measurement report (e.g., through the MN and/or SN, or through the primary path and/or the secondary path, or through an SRB3 or an SRB4 or a split SRB or a new SRB, etc.). If the information related to transmission of the first measurement report is RRC layer information, the information may be included in an RRC message (e.g., it may be an RRC reconfiguration message, etc.) sent by the first node to the UE.

The information related to transmission of the first measurement report may include at least one of the following items:
a first measurement information list, wherein the list includes one or more first measurement information, and each first measurement information may include at least one of the following items:
   a first measurement identifier (ID) for indicating one of a plurality of first measurements;
   information for indicating a transmission path, which is used to indicate path (or paths) through which the UE transmits the first measurement report; for example, the information for indicating the transmission path may indicate to transmit the first measurement report through the MN (or MCG) and/or the SN (or SCG) or may indicate whether to transmit the first measurement report over a specific first bearer (e.g., an SRB3 or a split SRB4 or a new SRB), or may set the MN as the primary path or secondary path for transmitting the first measurement report, or may set the SN as the primary path or secondary path for transmitting the first measurement report, however, the information is not limited to this;
   a threshold for indicating selection of the transmission path, which is used to indicate a threshold needs to be met when the UE can select to transmit the first measurement report through the SN (or SCG or the first bearer) and/or the MN (or MCG or SRB4) or the primary path and/or the secondary path. The threshold for indicating selection of the transmission path may include at least one of the following items: a message size value, the number of times of failures of scheduling requests, and a latency time for responding to the scheduling request, the number of the first measurement reports buffered, and/or time of buffering the first measurement report, etc. According to an embodiment, the threshold may be a message size value. When the size of the first measurement report exceeds the message size value in the configured threshold, the UE transmits the first measurement report through the SN (or SCG or the first bearer (e.g., including the SRB3, the split SRB4, and/or the new SRB)) or secondary path and/or MN (or MCG or SRB4) or primary path. If the size of the first measurement report does not exceed the message size value in the threshold, the UE transmits the first measurement report through the MN (or MCG or SRB4) or the primary path. According to another embodiment, the threshold may be the number of times the UE fails to send the scheduling request or the latency time for the responding to the scheduling request. If number of the times that the UE sends scheduling requests for transmission of the first measurement report but receives no response from the base station exceeds the number of times of failures of scheduling requests in the configured threshold, or the time from the initiation of the scheduling request to the time it has not been responded by the base station exceeds the latency time for responding to the scheduling request in the configured threshold, the UE transmits the first measurement report through the SN (or SCG or the first bearer) or the secondary path. Otherwise, the UE transmits the first measurement report through the MN (or MCG or SRB4) or the primary path. According to another embodiment, the threshold may be the number of first measurement reports buffered and/or the buffering time. When the number of first measurement reports buffered on the UE side exceeds the number of first measurement reports buffered in the threshold and/or when the time of buffering the first measurement report on the UE side exceeds the time of buffering the first measurement report in the threshold, the UE transmits the first measurement report through the SN (or the SCG or the first bearer) or the secondary path. Otherwise, the UE transmits the first measurement report through the MN (or MCG or SRB4) or the primary path. It should be understood that the above is only an example, and the thresholds for indicating selection of the transmission path and the methods for using the thresholds are not limited thereto. Since the UE may select an appropriate path according to the threshold, for example, UE may choose to transmit the first measurement report through the SN (or SCG or the first bearer) or the secondary path, or choose to transmit the first measurement report through the MN (or MCG or SRB4) or the primary path, or choose both the SN and the MN to transmit the first measurement report, compared with the case of only transmitting the first measurement report through the MN, the timeliness for transmitting the first measurement report and the integrity of the first measurement report may be ensured, and the UE is allowed to select the most suitable path to transmit the first measurement report according to the actual situation, which improves the efficiency of signal transmission.

In step 504, if the RRC reconfiguration process is completed and the first node receives the RRC reconfiguration complete message from the UE, the first node sends, to the third node, an SN Reconfiguration Complete message, which may include information for indicating a node collecting the first measurement report (i.e., a fourth node). If the node collecting the first measurement report is a base station, the information may be an ID of the base station (e.g., a gNB ID) or a cell ID (e.g., a cell global identity (CGI)). If the node collecting the first measurement report is the MCE, the information may be the address of the MCE or the MCE ID. In other words, according to the specific situation of the fourth node, the information for indicating the fourth node may include at least one of an identification and an address. After the third node receives the first measurement report from the UE, the third node may forward the first measurement report to the node that collects the first measurement report (i.e., the fourth node) according to the information.

In step 505, after the UE receives and saves the message and information in step 503, and when the UE needs to transmit a first measurement report, the UE determines to transmit the first measurement report through the SN (or SCG or the first bearer) and/or MN (or MCG or SRB4) or the primary path and/or the secondary path according to the first measurement ID corresponding to the first measurement report, the information for indicating a transmission path, and/or the threshold for indicating selection of the transmission path.

If the UE determines to transmit the first measurement report through the SN (or the SCG or the first bearer), the UE transmits the first measurement report (or at least a part thereof) to the third node. When the UE transmits the first measurement report through the first bearer (e.g. split SBR4) at both the SN and the MN, the UE may transmit at least a part of the first measurement report to the third node. Hereinafter, for the sake of brevity, “transmitting the first measurement report” includes transmitting at least a part of the first measurement report.

If the third node receives the first measurement report from the UE, the third node forwards the first measurement report to the fourth node, wherein the fourth node is a node for collecting the first measurement report, and the fourth node may be same with or different from the first node. According to an embodiment (such as step 506a), the third node directly sends the first measurement report to the fourth node according to the identification or address information received in step 504. According to another embodiment (such as step 506b), the third node sends the first measurement report to the first node, and the first node sends the first measurement report to the fourth node.

It should be understood that the above is only an example, and how the third node sends the first measurement report to the fourth node is not limited to this.

In step 506b, if the third node sends the first measurement report to the first node, the first measurement report may be included in an Xn application protocol (XnAP) message related to the UE. For example, the XnAP message may be an RRC transfer message or a forwarding QoE report message or a QoE report transfer, but it is not limited thereto.

Through the above wireless communication method, when a master base station has a high load, the UE may be able to transmit the measurement report of the UE (such as an application layer measurement report) through a secondary base station. This may ensure integrity and timeliness of transmission of the measurement report of the UE in the case the master base station has a high load, so that the carrier may obtain a complete measurement report and optimize and adjust the network, improving user experience. In the above method, the master base station may be able to dynamically adjust a transmission path of the measurement report according to the load situation to achieve the effect of load balancing. The above method allows a UE to be configured with a transmission method in advance, so that the UE may determine how to transmit the measurement report according to the actual situation, without the need for frequently instructing, by the master base station, the UE how to report the measurement result through signaling, thereby saving a lot of signaling overhead of the radio interface.

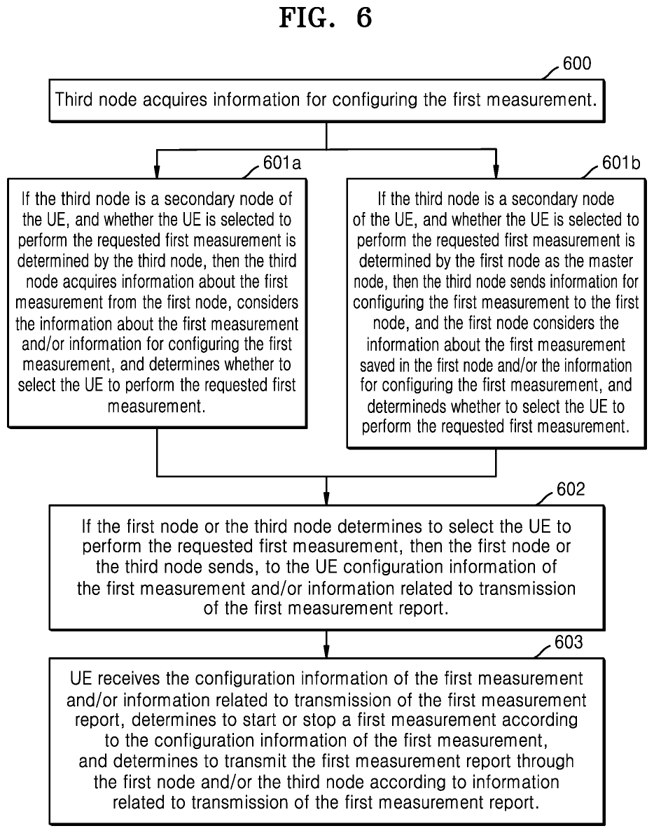

FIG. 6 is a flowchart illustrating a method for measurement configuration and reporting according to an embodiment.

Referring to FIG. 6, in step 600, the third node acquires information for configuring the first measurement. The information for configuring the first measurement may include first measurement configurations, service types, priorities and other information of one or more first measurements that are requested to be activated.

According to another embodiment, the information for configuring the first measurement may include first measurement configurations of one or more first measurements that are requested to be deactivated.

According to another embodiment, the information for configuring the first measurement may include first measurement configurations, service types, and priorities and other information of one or more first measurements that are requested to be modified.

It should be understood that the above-described information are only examples, and the information for configuring the first measurement is not limited thereto.

The third node may generate the information for configuring the first measurement by itself, may acquire the information for configuring the first measurement from the second node, or may generate information for configuring the first measurement according to the information from the second node.

It should be understood that the above are only examples, and how the third node acquires the information for configuring the first measurement is not limited thereto.

The second node may be a network element management node and/or a core network entity.

In step 601a, in a multi-connectivity scenario, if whether to select the UE to perform the requested first measurement (including, e.g., starting or stopping the first measurement) is determined by the SN, then the first node as the MN sends the information about the first measurement to the third node as the SN. The information about the first measurement may be included in an SN addition request message or an SN modification request message sent by the first node to the third node. It should be understood that the above messages are only examples, and the messages for transmitting the information about the first measurement are not limited thereto.

The third node considers the information about the first measurement and the information for configuring the first measurement acquired in step 600, and determines whether to select the UE to start (i.e., activate) or stop (i.e., deactivate) the first measurement requested in step 600. The first node may be an MN serving the UE in a multi-connectivity (e.g., MR-DC), and the third node may be an SN serving the UE.

In step 601b, in a multi-connectivity scenario, if the MN determines whether to select the UE to start or stop the requested first measurement, then the third node as the SN sends information for configuring the first measurement to the first node as the MN. The information for configuring the first measurement is included in the SN addition request acknowledge message, or the SN modification request acknowledge message, or an SN modification required message. It should be understood that the above messages are only examples, and the messages transmitting the information for configuring the first measurement are not limited thereto.

The first node considers the information for configuring the first measurement and/or the information about the first measurement stored in the first node, and determines whether to select the UE to start or stop the first measurement requested in step 600.

In step 602, if the first node or the third node determines to select the UE to start or stop the first measurement requested in step 600, then the first node or the third node sends to the UE the configuration information of the first measurement and/or information related to transmission of the first measurement report. The configuration information of the first measurement may be generated by the first node or by the third node. If step 601a is performed, and a signaling connection for transmitting the configuration information of the first measurement and/or the information related to transmission of the first measurement report is established between the third node and the UE, then the third node may sends to the UE the configuration information of the first measurement and/or the information related to transmission of the first measurement report directly through, e.g., an RRC reconfiguration procedure.

However, if step 601a is performed, and the signaling connection for transmitting the configuration information of the first measurement and/or information related to transmission of the first measurement report is not established between the third node and the UE, then the third node may send the configuration information of the first measurement to the first node after step 601a. The first node generates information related to transmission of the first measurement report, and sends the configuration information of the first measurement and/or the information related to transmission of the first measurement report to the UE through, e.g., an RRC reconfiguration procedure.

If step 601b is performed, and a signaling connection for transmitting the configuration information of the first measurement and/or information related to transmission of the first measurement report is established between the third node and the UE, then after the first node selects the UE to perform the first measurement, the first node indicates the result of the selection to the third node, and then the third node directly sends to the UE the configuration information of the first measurement and/or the information related to transmission of the first measurement report through the RRC reconfiguration process.

However, if step 601b is performed, and the signaling connection for transmitting the configuration information of the first measurement and/or the information related to transmission of the first measurement report is not established between the third node and the UE, the first node may send to UE the configuration information of the first measurement and/or information related to transmission of the first measurement report through the RRC reconfiguration process.

In step 603, the UE receives and saves the configuration information of the first measurement and/or the information related to transmission of the first measurement report, and determines whether to start or stop the first measurement according to the configuration information of the first measurement.

If it is determined to start the first measurement according to the configuration information of the first measurement and there is a first measurement report to be transmitted, the UE may determine to transmit the first measurement report through the first node and/or the third node according to the information related to transmission of the first measurement report. For example, the specific content and transmission method may be as described above with reference to FIG. 4 or FIG. 5.

If it is determined to stop the first measurement according to the configuration information of the first measurement, the UE may stop the first measurement.

Through the above-described wireless communication method, in a multi-connectivity scenario, even if the SN configures an application layer measurement (such as a QoE measurement), the application layer measurement configuration may be sent to the UE, without conflicting with the application layer measurement configuration of the MN, enabling carriers to more flexibly collect application layer measurement results in different coverage scenarios, so as to further optimize and adjust the network and improve user experience. The above-described method may also support that when the SN does not have a signaling connection with the UE, the application layer measurement requested by the SN is configured by the MN, and the above method may also support flexible reporting of the application layer measurement, so as to reduce the load of the base station, ensure the integrity of application layer measurement reports and the timeliness of reporting, so that carriers may obtain more comprehensive and timely application layer measurement results to optimize the network and improve user experience.

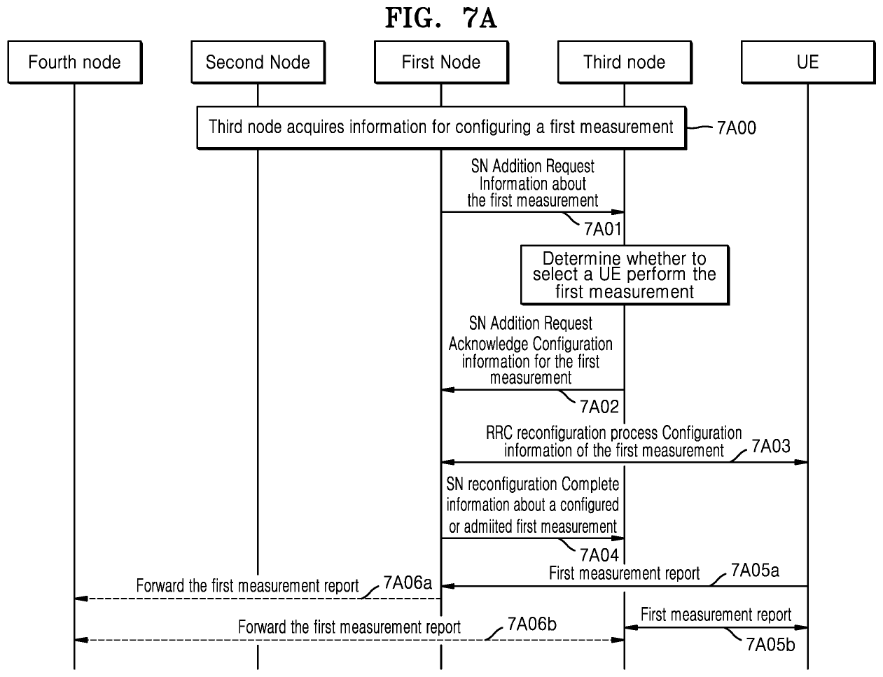

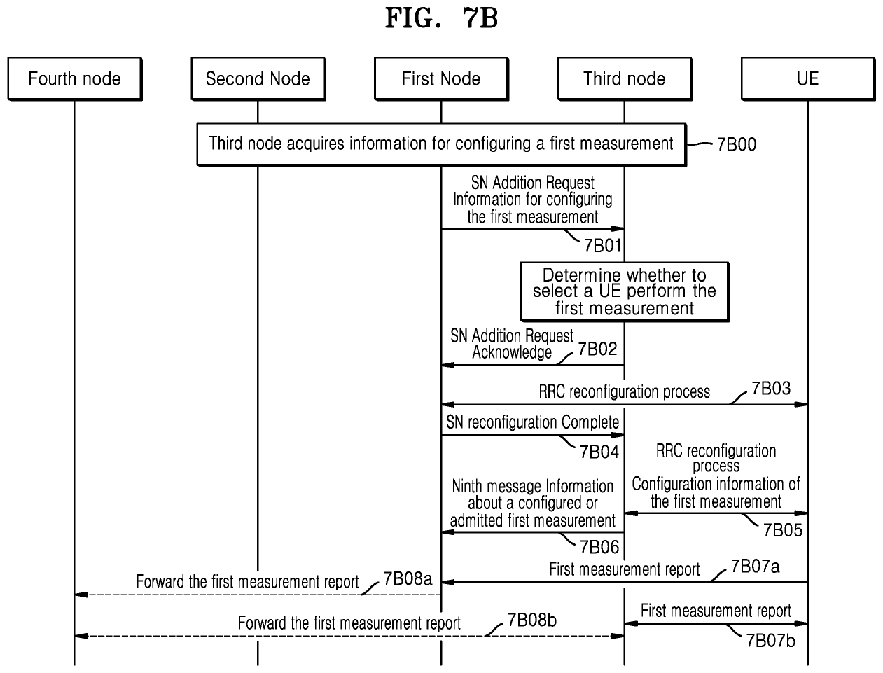

FIG. 7A is a signal flow diagram of a method for measurement configuration and reporting according to an embodiment. In FIG. 7A, the method is described using an activation of a first measurement as an example. Those skilled in the art should understand that the method of FIG. 7A is also applicable to cases of deactivating and/or modifying the first measurement at the UE.

Referring to FIG. 7A, in step 7A00, a third node acquires information for configuring the first measurement. The third node may be a base station, e.g., the SN in the MR-DC, and a first node may be the MN in the MR-DC. The information for configuring the first measurement may include first measurement configurations, service types, and priorities and other information of one or more first measurements that are requested to be activated. The third node may generate the information for configuring the first measurement by itself, may acquire the information for configuring the first measurement from a second node, or may generate information for configuring the first measurement according to information from a second node. It should be understood that the above is only an example, and how the third node acquires the information for configuring the first measurement is not limited thereto.

In step 7A01, the first node sends an SN addition request message to the third node. The message includes information about the first measurement. The first node may be an MN serving the UE in a multi-connectivity (e.g., MR-DC), and the third node may be an SN serving the UE.

The information about the first measurement may include at least one of the following items:
A capability of the UE to support the first measurement, wherein the capability may indicate whether the UE supports the first measurement of a certain service type. For example, the capability may indicate whether the UE supports the first measurement on a video service, whether the UE supports the first measurement on a voice service, and/or whether the UE supports the first measurement on a VR service, etc. Those skilled in the art should understand that the contents indicated by the above capability are only examples, and the capability may indicate whether the UE supports the first measurement on other service types, without departing from the scope of this disclosure;
A consent that the UE agrees to the first measurement, wherein the consent may indicate whether the UE agrees to perform the first measurement for a certain service type. For example, the consent may indicate whether the UE agrees to perform the first measurement on a video service, whether the UE agrees to perform the first measurement on a voice service, and/or whether the UE agrees to perform the first measurement on the VR service, etc, Those skilled in the art should understand that the contents indicated by the above consent are only examples, and the consent may indicate whether the UE agrees to perform the first measurement on other types of services, without departing from the scope of this disclosure; and/or
Information about the first measurement that has been configured by the UE, wherein the information about the first measurement that has been configured by the UE is information used to indicate the first measurement that has been configured for the UE, and the first measurement that has been configured for the UE may be one or more first measurements. Each configured first measurement may include at least one of the following items:
   a first measurement ID, which is used to indicate the configured first measurement, which may be an ID of the first measurement, e.g., the ID may be a QoE reference;
   a service type used to indicate which service type the configured first measurement is for, wherein the service type may include, e.g., a video service, a voice service, a VR, etc.; and/or
   a priority, which is used to indicate the priority of the configured first measurement. When there are multiple first measurements that can be configured for the same service type, the first measurement with a higher priority may be selected to configure the UE.

The third node receives and saves the information about the first measurement, and the third node compares the information about the first measurement with the information for configuring the first measurement acquired in step 7A00, and determines whether to select the UE to perform first measurement that is requested to be configured in step 7A00. That is, the corresponding first measurement configuration in the information for configuring the first measurement is sent to the UE. If the service type involved in the capability of the UE to support the first measurement and/or the consent that the UE agrees to the first measurement is consistent with the service type requested in step 7A00, then the UE supports the first measurement requested in step 7A00. That is, the third node may send the configuration information of the first measurement to the UE. Otherwise, the third node cannot select the UE to perform the first measurement requested in step 7A00.

If the service type in the information about the first measurement that has been configured by the UE is consistent with the service type requested in step 7A00, then the UE has been configured with the service type requested in 7A00. For the same service type, the third node may compare the priority in the information for configuring the first measurement in step 7A00 and the priority in the information about the first measurement that has been configured by the UE in step 7A01, and if the priority of the first measurement requested in step 7A00 is higher than the priority in the information about the first measurement that has been configured by the UE, then the third node determines to select the UE to perform the first measurement requested to be activated in step 7A00. That is, the third node may send the configuration information of the first measurement to the UE. Otherwise, the third node cannot select the UE to perform the first measurement requested in step 7A00. It should be understood that the above is only an example, and how the third node selects whether for the UE to perform the newly requested first measurement according to the information about the first measurement and the information for configuring the first measurement is not limited thereto.

In step 7A02, if the third node determines to select the UE to perform the first measurement requested in step 7A00, i.e., the third node determines to send the configuration information of the first measurement to the UE, and if there is no signaling connection between the third node and the UE, or the signaling connection between the third node and the UE does not support transmission of the configuration information of the first measurement, then the third node includes the configuration information of the first measurement in the SN addition request acknowledge message and sends it to the first node. The configuration information of the first measurement may be the same as or different from the information for configuring the first measurement acquired in step 7A00.

The SN addition request message and the SN addition request acknowledge message in steps 7A01 and 7A02 may also be replaced by the SN modification request message and the SN modification request acknowledge message respectively. That is, the information about the first measurement may also be included in the SN modification request message. When the third node determines to select the UE to perform the first measurement, the configuration information of the first measurement may also be included in the SN modification request acknowledge message.

Alternatively, step 7A00 may occur after step 7A01.

If 7A00 occurs after step 7A01, the SN addition request acknowledge message mentioned in step 7A02 may be replaced by an SN modification required message. That is, when the third node receives the information about the first measurement from step 7A01, saves the information, and receives the information for configuring the first measurement in step 7A00, the third node considers the information about the first measurement and/or information for configuring the first measurement, in order to determine whether to select the UE to perform the first measurement. If the UE is selected to perform the first measurement, the third node sends configuration information of the first measurement to the first node, and the configuration information of the first measurement may be included in the SN modification required message. The above messages for carrying the information about the first measurement and/or the configuration information of the first measurement are only examples, and other messages or other types of messages may also be used to carry the corresponding information without departing from the scope of the present disclosure.

In step 7A03, after the first node receives the SN addition request acknowledge message, if the message includes the configuration information of the first measurement, then the first node may send to the UE the configuration information of the first measurement through an RRC reconfiguration process. For example, the first node may include the configuration information of the first measurement in an RRC reconfiguration message to send to the UE. The UE may configure the first measurement according to the received configuration information of the first measurement. The UE may further indicate to the first node that the first measurement is successfully configured through, e.g., an RRC reconfiguration complete message.

Optionally, in the RRC reconfiguration process, the RRC reconfiguration message sent by the first node to the UE may further include information related to transmission of the first measurement report, and the content of the information is consistent with the content described in step 503, so it will not be described again here. The UE may determine how to transmit the first measurement report in consideration of the information related to transmission of the first measurement report.

In step 7A04, when the RRC reconfiguration process is completed, the first node saves the information about the first measurement successfully configured, and sends to the third node an SN reconfiguration complete message, which may include information about the configured or permitted first measurement to inform the third node whether the first measurement determined to be configured in step 7A02 is successfully configured.

The third node receives the SN reconfiguration complete message and saves the information about the configured or permitted first measurement.

If the UE starts to perform the first measurement configured in step 7A03 and there is a first measurement report to transmit, then the UE determines how to transmit the first measurement report according to the information related to transmission of the first measurement report received in step 7A03, i.e., the UE may transmit the first measurement report to the fourth node through the third node (or SCG) as the SN (e.g., in steps 7A05b and 7A06b), or the UE may transmit the first measurement report through the first node as the MN to the fourth node (e.g., in steps 7A05a and 7A06a). The fourth node collects and/or analyzes the first measurement report, which may be an MCE or a base station, and the fourth node may be the same as or different from the first node.

When the fourth node is different from the first node, after receiving the first measurement report, the first node should continue to forward the first measurement report to the fourth node. The fourth node may perform problem analysis according to the collected first measurement report, so as to optimize and adjust the network, thereby improving user experience.

Through the above-described wireless communication method, in a multi-connectivity scenario, even if the SN configures an application layer measurement (such as QoE measurement), the application layer measurement configuration may be sent to the UE, without conflicting with the application layer measurement configuration of the MN, allowing carriers to more flexibly collect application layer measurement results in different coverage scenarios, so as to further optimize and adjust the network and improve user experience. The above-described method may also support that when the SN does not have a signaling connection with the UE, the application layer measurement requested by the SN is configured by the MN, and meanwhile the above method may also support flexible reporting of the application layer measurement, so as to reduce the load of the base station, ensure the integrity of application layer measurement reports and the timeliness of reporting, so that carriers may be able to obtain more comprehensive and timely application layer measurement results to optimize the network and improve user experience.

FIG. 7B is a signal flow diagram of a method for measurement configuration and reporting according to an embodiment.

Referring to FIG. 7B, steps 7B00 and 7B01 are respectively the same as steps 7A00 and 7A01, and as such, will not be described again here.

In step 7B02, the third node sends an SN addition request acknowledge message to the first node. The SN addition request message and the SN addition request acknowledge message mentioned in step 7B01 and step 7B02 may also be replaced by the SN modification request message and the SN modification request acknowledge message respectively. That is, the information about the first measurement may also be included in the SN modification request message, and when the third node determines to select the UE to perform the first measurement, the SN modification request acknowledge message may also be sent to the first node.

Similar to FIG. 7A, step 7B00 may occur after step 7B01.

If 7B00 occurs after step 7B01, the SN addition request acknowledge message in step 7B02 may be replaced by an SN modification required message. That is, when the third node receives the information about the first measurement from step 7B01, saves the information, and receives the information for configuring the first measurement in step 7B00, the third node considers the information about the first measurement and/or information for configuring the first measurement, in order to determine whether to select the UE to perform the first measurement. If the UE is selected to perform the first measurement, then the third node sends configuration information of the first measurement to the first node, and the configuration information of the first measurement may be included in the SN modification required message.

In step 7B03, the first node initiates an RRC reconfiguration process with the UE, wherein the RRC reconfiguration process includes establishing a signaling connection between the UE and the third node (e.g., establishing an SRB3, a split SRB or other SRBs), and the signaling connection supports sending the configuration information of the first measurement by the third node to the UE.

In step 7B04, when the RRC reconfiguration process in step 7B03 is completed, the first node may send an SN reconfiguration complete message to the third node to notify the third node that the signaling connection between the UE and the third node has been established.

In step 7B05, the third node initiates an RRC reconfiguration process to the UE, and the RRC message in the RRC reconfiguration process is transmitted by the signaling connection established in step 7B03. In the RRC reconfiguration process, the RRC reconfiguration message sent by the third node to the UE may include the configuration information of the first measurement. The UE may configure the first measurement according to the configuration information of the first measurement. The RRC reconfiguration message sent by the third node to the UE may further include information related to transmission of the first measurement report, and the content of the information is consistent with the content described in step 503, and will not be described again here. The UE may determine how to transmit the first measurement report in consideration of the information related to transmission of the first measurement report.

The UE receives and saves the configuration information of the first measurement and/or the information related to transmission of the first measurement report.

In step 7B06, after the RRC reconfiguration process in step 7B05 is completed, the third node sends to the first node information about the configured or permitted first measurement, and the information about the configured or permitted first measurement will be included in a ninth message, which may be an XnAP message, but is not limited thereto. The information about the configured or permitted first measurement may indicate the first measurement configured to the UE by the third node, which may be one or more first measurements, and each configured first measurement may include at least one of the following items:
1) information for indicating a successfully configured first measurement, for example, the information may be IDs of one or more first measurements successfully configured;
2) information for indicating a unsuccessfully configured first measurement, for example, the information may be IDs and/or failure reasons of one or more unsuccessfully configured first measurements;
3) information for indicating the first measurement that is permitted to be configured, for example, the information may indicate IDs of one or more first measurements that are permitted to be configured; and/or
4) information for indicating the first measurement that is not permitted to be configured, e.g., the information may indicate IDs of one or more first measurements that are not permitted to be configured and/or the reason for not being permitted to be configured.

The first node receives and stores the information about the configured or permitted first measurement.

If the UE starts to perform the first measurement configured in step 7B05 and there is a first measurement report to transmit, the UE determines how to transmit the first measurement report according to the information related to transmission of the first measurement report received in step 7B05. That is, the UE may transmit the first measurement report to the fourth node through the third node (or SCG) as the SN (e.g., in steps 7B07b and 7B08b), or the UE may transmit the first measurement report through the first node as the MN to the fourth node (e.g., in steps 7B07a and 7B08a). The fourth node is a node for collecting and/or analyzing the first measurement report, which may be an MCE or a base station, and the fourth node may be the same as or different from the first node. When the fourth node is different from the first node, after receiving the first measurement report, the first node needs to continue to forward the first measurement report to the fourth node. The fourth node may perform problem analysis according to the collected first measurement report, so as to optimize and adjust the network, thereby improving user experience.

Through the above-described wireless communication method, in a multi-connectivity scenario, even if the SN configures an application layer measurement (such as QoE measurement), the application layer measurement configuration may be sent to the UE, without conflicting with the application layer measurement configuration of the MN, allowing carriers to more flexibly collect application layer measurement results in different coverage scenarios, so as to further optimize and adjust the network and improve user experience. The above-described method may also support that when the SN does not have a signaling connection with the UE, the application layer measurement requested by the SN is configured by the MN. The above-described method may also support flexible reporting of the application layer measurement, so as to reduce the load of the base station, and ensure the integrity of application layer measurement reports and the timeliness of reporting, so that carriers may be able to obtain more comprehensive and timely application layer measurement results to optimize the network and improve user experience.

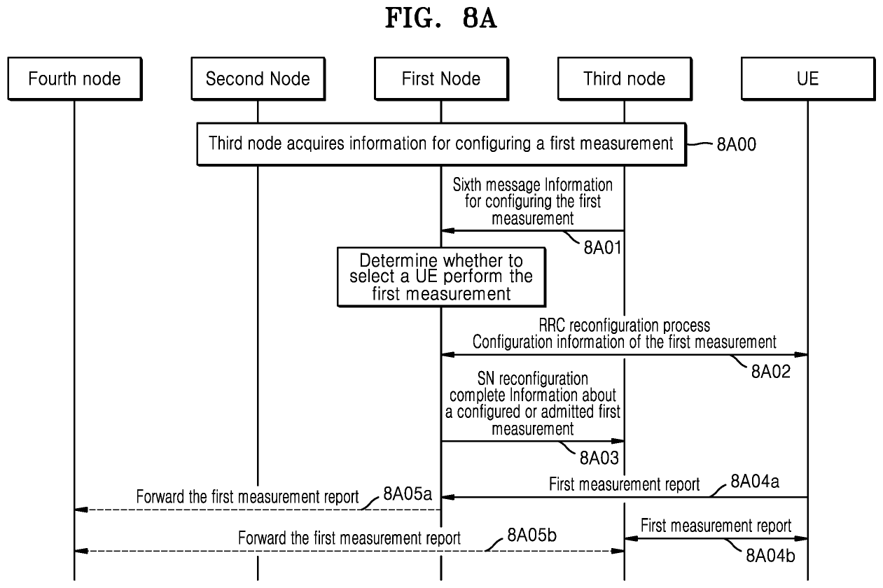

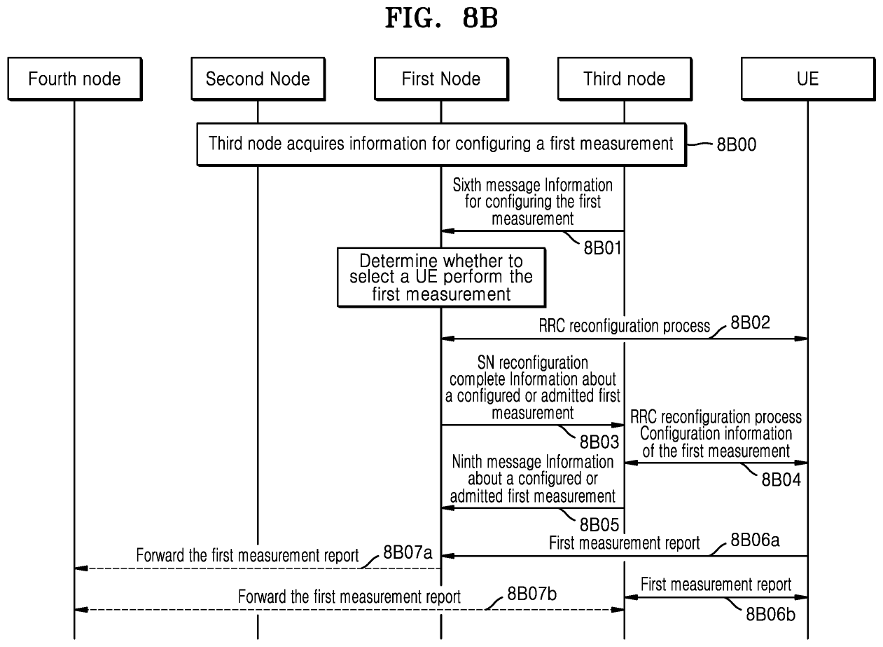

FIG. 8A is a signal flow diagram of a method for measurement configuration and reporting according to an embodiment.

Referring to FIG. 8A, step 8A00 is the same as step 7A00, and will not be described again here.

In step 8A01, the third node sends a sixth message to the first node. The sixth message may include information for configuring the first measurement, and the information for configuring the first measurement includes information of first measurement configurations, service types, priorities, etc., of one or more first measurements that are requested to be activated. The information for configuring the first measurement is included in the sixth message, and the sixth message may be an SN addition request acknowledge message, or an SN modification request acknowledge message, or an SN modification required message, or other SN-related XnAP messages. The first node may be an MN serving the UE in a multi-connectivity (e.g., MR-DC), and the third node may be an SN serving the UE.

The first node receives the information for configuring the first measurement, and determines whether to select the UE to perform the first measurement that is requested to be activated according to the information for configuring the first measurement, the capability of the UE to support the first measurement, the consent that the UE agrees to the first measurement, and/or information about the first measurement that has been configured by the UE. The first measurement that is requested to be activated is requested to be activated by the third node, and is included in the sixth message. The six message may be an SN addition acknowledge message, an SN modification request acknowledge message, or another XnAP message.

If the service type involved in the capability of the UE to support the first measurement and/or the consent that the UE agrees to the first measurement is consistent with the service type requested in step 8A00, then the UE supports the first measurement requested in step 8A00. That is, the first node may send the configuration information of the first measurement to the UE. Otherwise, the first node cannot select the UE to perform the first measurement requested in step 8A00.

If the service type in the information about the first measurement that has been configured by the UE is consistent with the service type requested in step 8A00, then the UE has been configured with the service type requested in 8A00. For the same service type, the first node compares the priority in the information for configuring the first measurement in step 8A00 and the priority in the information about the first measurement that has been configured by the UE, and if the priority of the first measurement requested in step 8A00 is higher than the priority in the information about the first measurement that has been configured by the UE, the first node may determine to select the UE to perform the first measurement requested to be activated in step 8A00. That is, the first node may send the configuration information of the first measurement to the UE. Otherwise, the first node cannot select the UE to perform the first measurement requested in step 8A00. It should be understood that the above is only an example, and how the first node selects whether for the UE to perform the newly requested first measurement according to the information about the first measurement and the information for configuring the first measurement is not limited thereto.

In step 8A02, if the first node selects the UE to perform the requested first measurement, then the first node initiates an RRC reconfiguration process to the UE. In the RRC reconfiguration process, the RRC reconfiguration message sent by the first node to the UE includes the configuration information of the first measurement. The UE may configure the first measurement according to the configuration information of the first measurement, and the UE may indicate to the first node whether the first measurement is successfully configured through an RRC reconfiguration complete message. The RRC reconfiguration message sent by the first node to the UE may further include information related to transmission of the first measurement report, and the content of the information is consistent with the content described in step 503, and will not be described again here. The UE may determine how to transmit the first measurement report in consideration of the information related to transmission of the first measurement report.

The UE receives and saves the configuration information of the first measurement and/or the information related to transmission of the first measurement report.

In step 8A03, after the RRC reconfiguration process is completed, the first node obtains the information about the first measurement successfully configured, and sends to the third node an SN reconfiguration complete message, which may include information about the configured or permitted first measurement to inform the third node whether the first measurement requested in step 8A01 is successfully configured. The information about the configured or permitted first measurement may include at least one of the following items:
1) information for indicating a successfully configured first measurement, for example, the information may be IDs of one or more first measurements successfully configured;
2) information for indicating a unsuccessfully configured first measurement, e.g., the information may be IDs and/or failure reasons of one or more unsuccessfully configured first measurements;
3) information for indicating a first measurement that is permitted to be configured, e.g., the information may indicate IDs of one or more first measurements that are permitted to be configured; and/or
4) information for indicating a first measurement that is not permitted to be configured, e.g., the information may indicate IDs of one or more first measurements that are not permitted to be configured and/or the reason for not being permitted to be configured.

The third node receives and stores the information about the configured or permitted first measurement.

If the UE starts to perform the first measurement configured in step 8A02 and there is a first measurement report to transmit, the UE may determine how to transmit the first measurement report according to the information related to transmission of the first measurement report received in step 8A02. that is, the UE may transmit the first measurement report to the fourth node through the third node (or SCG) as the SN (e.g., in steps 8A04b and 8A05b), or the UE may transmit the first measurement report through the first node as the MN to the fourth node (e.g., in steps 8A04a and 8A05a). The fourth node is a node for collecting and/or analyzing the first measurement report, which may be an MCE or a base station, and the fourth node may be the same as or different from the first node. When the fourth node is different from the first node, after receiving the first measurement report, the first node needs to continue to forward the first measurement report to the fourth node. The fourth node may perform problem analysis according to the collected first measurement report, so as to optimize and adjust the network, thereby improving user experience.

Through the above-described wireless communication method, in a multi-connectivity scenario, even if the SN configures an application layer measurement (such as QoE measurement), the application layer measurement configuration may be sent to the UE, without conflicting with the application layer measurement configuration of the MN, allowing carriers to more flexibly collect application layer measurement results in different coverage scenarios, so as to further optimize and adjust the network and improve user experience. The above-described method may also support that when the SN does not have a signaling connection with the UE, the application layer measurement requested by the SN is configured by the MN. The above-described method may also support flexible reporting of the application layer measurement, so as to reduce the load of the base station and ensure the integrity of application layer measurement reports and the timeliness of reporting, so that carriers may obtain more comprehensive and timely application layer measurement results to optimize the network and improve user experience.

FIG. 8B is a signal flow diagram of a method for measurement configuration and reporting according to an embodiment.

Referring to FIG. 8B, steps 8B00 and 8B01 are respectively with the same as steps 8A00 and 8A01, and will not be described again here.

In step 8B02, the first node initiates an RRC reconfiguration process with the UE. The RRC reconfiguration process includes establishing a signaling connection between the UE and the third node (e.g., establishing an SRB3, a split SRB or other SRBs), and the signaling connection supports sending the configuration information of the first measurement by the third node to the UE.

In step 8B03, when the RRC reconfiguration process in step 8B02 is completed, the first node sends an SN reconfiguration complete message to the third node. The SN reconfiguration complete message includes information about the configured or permitted first measurement, and the content of the information about the configured or permitted first measurement is consistent with the content described in step 8A03, which is not described again here.

The third node receives the information about the configured or permitted first measurements.

In step 8B04, if the information about the configured or permitted first measurement includes an ID of the first measurement selected by the first node, then the third node initiates an RRC reconfiguration process to the UE. In the RRC reconfiguration process, the RRC reconfiguration message sent by the third node to the UE includes the configuration information of the first measurement. The UE may configure the first measurement according to the configuration information of the first measurement. The UE may indicate to the third node that the first measurement is successfully configured through an RRC reconfiguration complete message during the RRC reconfiguration process. The RRC message in the RRC reconfiguration process is transmitted by the signaling connection established in step 8B02. The RRC reconfiguration message sent by the third node to the UE may further include information related to transmission of the first measurement report, and the content of the information is consistent with the content described in step 503, and will not be described again here. The UE may determine how to transmit the first measurement report in consideration of the information related to transmission of the first measurement report.

The UE receives and saves the configuration information of the first measurement and/or the information related to transmission of the first measurement report.

In step 8B05, after the RRC reconfiguration process is completed, the third node sends information about the configured or permitted first measurement to the first node, the content of the information is consistent with the content described in step 7B06, and will not be described again here.

If the UE starts to perform the first measurement configured in step 8B04 and there is a first measurement report to transmit, the UE determines how to transmit the first measurement report according to the information related to transmission of the first measurement report received in step 8B04. That is, the UE may transmit the first measurement report to the fourth node through the third node (or SCG) as the SN (e.g., in steps 8B06b and 8B07b), or the UE may transmit the first measurement report through the first node as the MN to the fourth node (e.g., in steps 8B06a and 8B07a). The fourth node is a node for collecting and/or analyzing the first measurement report, which may be an MCE or a base station, and the fourth node may be the same as or different from the first node. When the fourth node is different from the first node, after receiving the first measurement report, the first node should continue to forward the first measurement report to the fourth node. The fourth node may perform problem analysis according to the collected first measurement report, so as to optimize and adjust the network, thereby improving user experience.

Through the above-described wireless communication method, in a multi-connectivity scenario, even if the SN configures an application layer measurement (such as QoE measurement), the application layer measurement configuration may be sent to the UE, without conflicting with the application layer measurement configuration of the MN, allowing carriers to more flexibly collect application layer measurement results in different coverage scenarios, so as to further optimize and adjust the network and improve user experience. The above-described method may also support that when the SN does not have a signaling connection with the UE, the application layer measurement requested by the SN is configured by the MN. The above-described method may also support flexible reporting of the application layer measurement, so as to reduce the load of the base station, and ensure the integrity of application layer measurement reports and the timeliness of reporting, so that carriers may obtain more comprehensive and timely application layer measurement results to optimize the network and improve user experience.

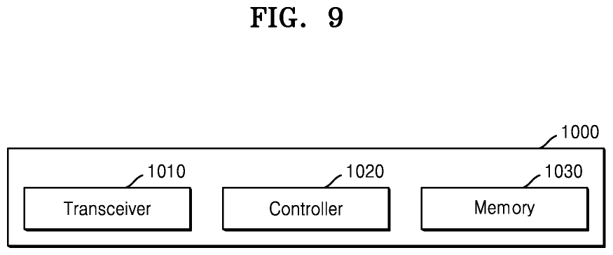

FIG. 9 illustrates a node according to an embodiment. For example, a node is used here to illustrate its structure and function, but it should be understood that the shown structure and function may also be applied to a base station (or a CU, a CU-control plane (CP), a CU-user plane (UP), a DU, etc.).

Referring to FIG. 9, a node 1000 includes a transceiver 1010, a controller 1020, and a memory 1030. Under the control of the controller 1020 (which may be implemented as one or more processors), the node 1000 is configured to perform the operations of the node described above. Although the transceiver 1010, the controller 1020, and the memory 1030 are shown as separate entities, they may be embodied as a single entity, such as a single chip. The transceiver 1010, the controller 1020, and the memory 1030 may be electrically connected or coupled with each other. The transceiver 1010 may transmit and receive signals to and from another network entity, wherein the another network entity may be for example another node and/or UE, etc.

Alternatively, the transceiver 1010 may be omitted. In this case, the controller 1020 may be configured to execute instructions (including computer programs) stored in the memory 1030 to control the overall operation of the node 1000 to implement the operations of the node described in this disclosure.

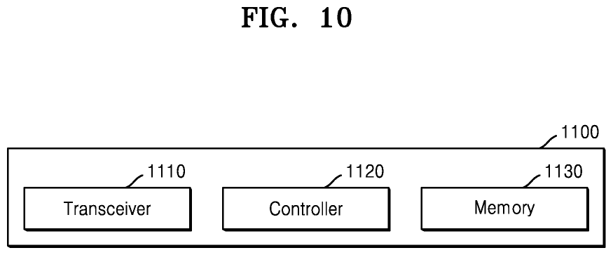

FIG. 10 illustrates a UE according to an embodiment.

Referring to FIG. 10, a UE 1100 includes a transceiver 1110, a controller 1120, and a memory 1130. Under the control of the controller 1120 (which may be implemented as one or more processors), the UE 1100 is configured to perform the operations of the UE described above. Although the transceiver 1110, the controller 1120 and the memory 1130 are shown as separate entities, they may be embodied as a single entity, such as a single chip. The transceiver 1110, the controller 1120, and the memory 1130 may be electrically connected or coupled with each other. The transceiver 1110 may transmit and receive signals to and from another network entity, wherein the another network entity may be for example a node, another UE, etc.

Alternatively, the transceiver 1110 may be omitted. In this case, the controller 1120 may be configured to execute instructions (including computer programs) stored in the memory 1130 to control the overall operation of the UE 1100 to implement the operations of the UE described in this disclosure.

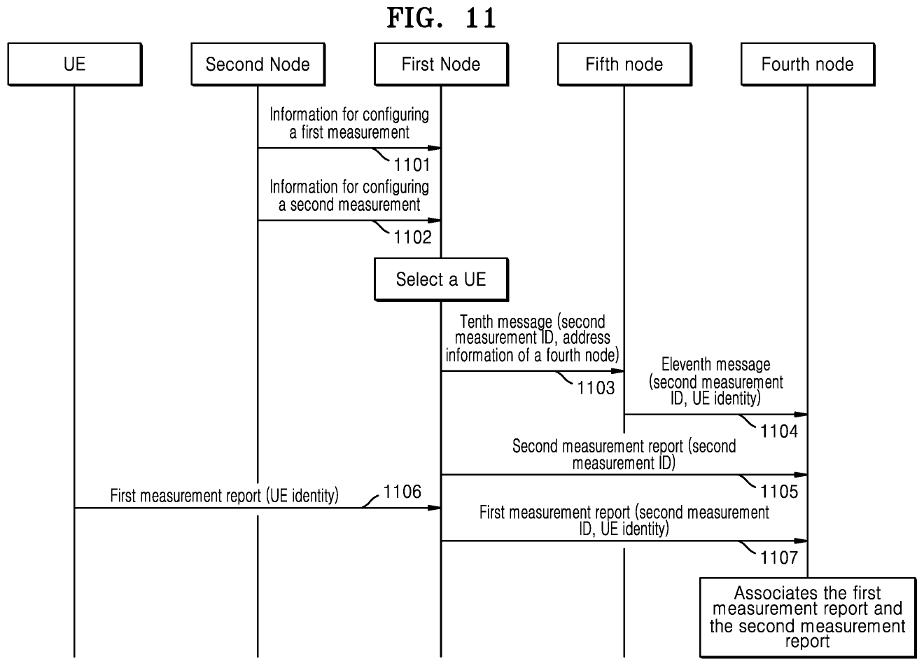

FIG. 11 is a signal flow diagram of a method for measurement configuration and reporting according to an embodiment.

Referring to FIG. 11, in step 1101, a second node sends, to a first node, information for configuring the first measurement. The second node may be an OAM or an element manager (EM), the first node may be a base station, and the information for configuring the first measurement may be included in messages for activating QoE or QMC. The first measurement may be a management-based QoE measurement. It should be understood that the examples of the second node, the first node, and the type of the first measurement are not limited thereto. The information for configuring the first measurement includes address information of a fourth node, wherein the fourth node is a node for collecting the first measurement result, i.e., the first measurement report, such as an MCE.

In step 1102, the second node sends, to the first node, information for configuring a second measurement. The information for configuring the second measurement may be included in a trace session activation message. The second measurement is a management-based minimization of drive-test (MDT) measurement. It should be understood that the example type of the second measurement is not limited thereto. The information for configuring the second measurement includes an ID for identifying the current measurement task, e.g., the trace reference.

It should be understood that steps 1101 and 1102 may occur simultaneously, or the sequence may be reversed.

In step 1103, the first node selects a UE according to the information for configuring the first measurement and/or the information for configuring the second measurement. If the UE is selected to perform the first measurement and the second measurement at the same time, and the UE's first measurement and second measurement need to be associated, e.g., if an indication that the first measurement and the second measurement should be associated is included in the information for configuring the first measurement and/or the information for configuring the second measurement, then the first node should send to the fourth node the received first measurement report and second measurement report from the UE and/or the second measurement report generated by the first node itself.

If the first measurement result (i.e. the first measurement report) and the second measurement result (i.e. the second measurement report) should be associated at the fourth node, then the first node sends a tenth message to a fifth node, and the fifth node is a node with a UE's globally unique identifier, e.g., the fifth node may be a core network node, the core network node may be an AMF, and the tenth message may be a cell traffic trace message, but the tenth message is not limited to this. The tenth message may include at least one of the following items:
1) a second measurement ID for identifying a specific second measurement task, e.g., the second measurement ID may be an NG-RAN Trace ID, and the NG-RAN Trace ID may include a trace reference and a trace recording session reference;
2) a fourth node address information for indicating an address information of a fourth node, the address information of the fourth node may be one or more address information, such as an MCE address list. The address information may be in the form of an IP address (such as an MCE IP address list or MCE IP address), or domain name, etc., to ultimately let the fifth node send the associated second measurement ID and UE identity to the fourth node, so that the fourth node knows from which UE the second measurement report is received, to associate the second measurement with the first measurement with the same UE identity; and/or
3) an interface UE ID (e.g., an AMF UE NGAP ID and a RAN UE NGAP ID).

In step 1104, after the fifth node receives the tenth message and information, the fifth node queries and obtains the UE identity according to the interface UE ID (e.g., the AMF UE NGAP ID and the RAN UE NGAP ID) in the tenth message. The UE identity is a globally unique identifier of the UE, e.g., an identifier such as an international mobile subscriber identification (IMSI), and/or an international mobile equipment identity (IMEI). The fifth node sends an eleventh message to the fourth node according to the fourth node address information in the tenth message, wherein the eleventh message includes the second measurement ID and the UE identity, and the UE identity is the UE identity associated with the second measurement ID. The fourth node receives and saves the information.

In step 1105, the first node receives from the UE and/or generates a second measurement report including the second measurement result. Optionally, the second measurement report further includes time information. The first node sends the second measurement report to the fourth node, wherein the report includes the second measurement result and the second measurement ID. The fourth node receives and saves the second measurement report. The fourth node may obtain the UE identity associated with the second measurement report according to the second measurement ID in the second measurement report and the UE identity associated with the second measurement ID saved in step 1104, i.e., the fourth node may determine which UE the second measurement report is for.

In step 1106, the UE sends a first measurement report to the first node. The first measurement report includes the first measurement result and/or the UE identity. Optionally, the first measurement report further includes time information.

In step 1107, after the first node receives the first measurement report, the first node includes the associated second measurement ID in the first measurement report, and then sends the first measurement report, to the fourth node. That is, the first measurement report includes the first measurement result, the second measurement ID, and the UE identity. The fourth node receives and saves the first measurement report.

In this way, the fourth node associates the first measurement report with the second measurement report according to the UE identity associated with the second measurement report obtained in step 1105 and the UE identity in the first measurement report obtained in step 1107. For example, if the UE identity associated with the second measurement report obtained in step 1105 is the same as the UE identity in the first measurement report obtained in step 1107, then the first measurement report and the second measurement report are measurement reports for the same UE, the fourth node associates (e.g., by time) the two measurement reports further according to the information (e.g., time information) in the first measurement report and the second measurement report, so as to combine the measurement results of two different dimensions to analyze network problems, and based on the results of the analysis, further optimize and adjust the network.

Through the above-described wireless communication method, the association between UE application layer measurement (i.e., QoE measurement) and MDT measurement results may be realized, so that the node for collecting the measurement reports analyze and optimize network problems according to the measurement results of two different dimensions, which may help carriers to quickly associate measurement results from different entities and dimensions, locate problematic UEs, analyze problems, and solve problems, thereby improving user experience, increasing user loyalty, and increasing revenue for carriers.

In the above-described embodiments of the present disclosure, all operations and messages may be selectively performed or may be omitted. Further, the operations in each embodiment need not be performed sequentially, and the order of operations may vary. Messages do not need to be delivered sequentially, and the order for delivery of messages may vary. Each operation and each message transfer may be performed independently.

While the disclosure has been shown and described with reference to various embodiments of the present disclosure, those skilled in the art will appreciate that, without departing from the spirit and scope of the present disclosure as defined by the appended claims and their equivalents, various changes may be made to the form and detail thereof.

What is claimed is:

1. A method performed by a third node in a communication system, the method comprising:
receiving, from a first node, information about a first measurement; and
performing at least one of sending configuration information of the first measurement to the first node, or sending, to a fourth node, a first measurement report received from a user equipment (UE).

2. The method of claim 1, further comprising receiving the configuration information of the first measurement from a second node,
wherein the configuration information of the first measurement includes priorities of one or more first measurements requested to be at least one of activated, deactivated, or modified.

3. The method of claim 1, further comprising:
sending the configuration information of the first measurement to the first node; and, receiving information about a configured or permitted first measurement from the first node,
wherein the information about the configured or permitted first measurement is received from the first node, after the first node sends the configuration information of the first measurement to the UE.

4. The method of claim 1, further comprising:
receiving from the first node the information about the first measurement; and
sending information about a configured or permitted first measurement to the first node,
wherein the information about the configured or permitted first measurement is sent to the first node, after the third node determines whether to select the UE to perform the first measurement based on the information about the first measurement and sends the configuration information of the first measurement to the UE.

5. The method of claim 4, wherein the information about the configured or permitted first measurement comprises at least one of:
information indicating a successfully configured first measurement,
information indicating an unsuccessfully configured first measurement,
information indicating the first measurement is permitted to be configured, or
information for indicating the first measurement is not permitted to be configured.

6. The method of claim 1, further comprising:
sending the configuration information of the first measurement to the first node; and
receiving information about a configured or permitted first measurement from the first node,
wherein the information about the configured or permitted first measurement is received from the first node, after the first node determines whether to select the UE to perform the first measurement based on the configuration information of the first measurement and sends the configuration information of the first measurement to the UE.

7. The method of claim 1, further comprising:
sending the configuration information of the first measurement to the first node;
receiving information about a configured or permitted first measurement from the first node, wherein the information about the configured or permitted first measurement is received from the first node, after the first node determines whether to select the UE to perform the first measurement based on the configuration information of the first measurement; and
sending the information about the configured or permitted first measurement to the first node, wherein the information about the configured or permitted first measurement is sent to the first node, after the third node sends the configuration information of the first measurement to the UE.

8. The method of claim 1, wherein the information about the first measurement comprises at least one of a capability of the UE to support the first measurement, a consent that the UE agrees to the first measurement, or information about the first measurement that has been configured by the UE.

9. The method of claim 1, wherein sending the first measurement report to the fourth node comprises:
receiving, from the first node, request information about a first bearer;
sending, to the first node, feedback information about the first bearer;
receiving a first measurement report form the UE, wherein the first measurement report is received over the first bearer; and
sending the first measurement report to the fourth node.

10. The method of claim 9, wherein the request information about the first bearer comprises at least one of:
information indicating that there is the first measurement,
information requesting information about the first bearer, or
information requesting establishment of the first bearer, and
wherein the feedback information about the first bearer comprises at least one of:
information indicating to prepare to establish the first bearer,
information indicating establishment of the first bearer, or
information indicating permission to establish the first bearer.

11. A method performed by a first node in a communication system, the method comprising:
sending, to a third node, information about a first measurement; and
receiving, from the third node, configuration information of the first measurement.

12. The method of claim 11, further comprising:
sending, to a user equipment (UE), the configuration information of the first measurement; and
sending, to the third node, information about a configured or permitted first measurement.

13. The method of claim 11, further comprising:
sending to the third node the information about the first measurement; and
receiving, from the third node, information about a configured or permitted first measurement,
wherein the information about the configured or permitted first measurement is received from the third node, after the third node determines whether to select a user equipment (UE) to perform the first measurement based on the information about the first measurement, and sends the configuration information of the first measurement to the UE.

14. The method of claim 13, wherein the information about the configured or permitted first measurement comprises at least one of:
information indicating a successfully configured first measurement,
information indicating an unsuccessfully configured first measurement,
information indicating the first measurement is permitted to be configured, or
information indicating the first measurement is not permitted to be configured.

15. The method of claim 11, further comprising:
determining whether to select a user equipment (UE) to perform the first measurement based on the configuration information of the first measurement;
sending the configuration information of the first measurement to the UE; and
sending, to the third node, information about a configured or permitted first measurement.

16. The method of claim 11, further comprising:
determining whether to select a user equipment (UE) to perform the first measurement based on the configuration information of the first measurement;
sending information about a configured or permitted first measurement to the third node; and
receiving the information about the configured or permitted first measurement from the third node,
wherein the information about the configured or permitted first measurement is received from the third node, after the third node sends the configuration information of the first measurement to the UE.

17. The method of claim 11, wherein the information about the first measurement comprises at least one of:
a capability of the UE to support the first measurement,
a consent that the UE agrees to the first measurement, or
information about the first measurement that has been configured by the UE.

18. The method of claim 11, further comprising:
sending, to the third node, request information about a first bearer;
receiving, from the third node, feedback information about the first bearer; and
sending, to a user equipment (UE), information related to transmission of a first measurement report,
wherein the first measurement report is sent over the first bearer.

19. The method of claim 18, wherein the request information about the first bearer comprises at least one of:
information indicating that there is the first measurement,
information requesting information about the first bearer, or
information requesting establishment of the first bearer, and
wherein the feedback information about the first bearer comprises at least one of:
information indicating to prepare to establish the first bearer,
information indicating establishment of the first bearer, or
information indicating permission to establish the first bearer.

20. A third node for performing communication in a communication system, the third node comprising:
a transceiver, and
at least one controller coupled with the transceiver and configured to:
receive, from a first node, information about a first measurement, and
perform at least one of sending configuration information of the first measurement to the first node, or sending, to a fourth node, a first measurement report received from a user equipment (UE).
